(19) United States
(12) Patent Application Publication
(10) Pub. No.: US 2026/0112763 A1
(43) Pub. Date: Apr. 23, 2026

(54) BATTERY CASE AND BATTERY MODULE INCLUDNG THE SAME

(71) Applicant: SK ON CO., LTD., Seoul (KR)

(72) Inventors: In Seob KANG, Daejeon (KR); Ji Sang YOON, Daejeon (KR)

(21) Appl. No.: 19/262,106

(22) Filed: Jul. 8, 2025

(30) Foreign Application Priority Data
Oct. 22, 2024 (KR) 10-2024-0144496

(51) Int. Cl. H01M 50/271; H01M 50/211; H01M 50/242

(52) U.S. Cl. CPC H01M 50/271; H01M 50/211; H01M 50/242

(57) ABSTRACT

A battery module includes a plurality of battery cells and a battery case accommodating the plurality of battery cells and including a first cover covering the plurality of battery cells and a second cover facing the plurality of battery cells in a stacking direction of the plurality of battery cells, wherein the second cover includes a body portion facing the plurality of battery cells, a first flange portion disposed inside the battery case and protruding from the body portion toward the first cover, and a second flange portion disposed outside the battery case, facing the first flange portion, and protruding from the body portion toward the first cover.

### CROSS-REFERENCE TO RELATED APPLICATION(S)

This patent document claims the priority and benefits of Korean Patent Application No. 10-2024-0144496 filed on Oct. 22, 2024, the disclosure of which is incorporated herein by reference in its entirety.

### TECHNICAL FIELD

The disclosure and implementations disclosed in this patent document generally relate to a battery case and a battery module including the same.

### BACKGROUND

Secondary batteries, unlike primary batteries, have the convenience of being able to be charged with and discharged of electricity, and are thus have come to prominence as a power source for various mobile devices and electric vehicles. Secondary batteries, unlike primary batteries, may be charged with and discharged of electricity and may be applied in various fields, such as digital cameras, mobile phones, laptops, hybrid vehicles, electric vehicles, and energy storage systems (ESS).

Such secondary batteries may include battery cells in which an electrode assembly formed by stacking a positive electrode plate, a negative electrode plate, and a separator or winding them in a roll shape is accommodated inside a case. A plurality of battery cells may be stacked in a predetermined direction and accommodated in a battery module or battery pack.

Meanwhile, when swelling occurs in a battery cell and the battery cell expands, the case of the battery module or battery pack is compressed, and at this time, the case may be deformed or broken due to the pressure caused by the expansion of the battery cell. In addition, when the case is welded, welding heat may affect the battery cells disposed therein. Accordingly, research on structurally stable casing technology has become important.

### SUMMARY

The present disclosure may be implemented in some embodiments to provide a battery case capable of stably supporting pressure due to swelling of a battery cell and a battery module including the same.

The present disclosure may also be implemented in some embodiments to provide a battery case on which welding may be efficiently performed and a battery module including the same.

The present disclosure may also be implemented in some embodiments to provide a battery case having a structure in which propagation of heat generated during welding to a battery cell is reduced and a battery module including the same.

Meanwhile, the present disclosure may be widely applied to battery charging stations and green technology fields, such as solar power generation and wind power generation using batteries. In addition, the present disclosure may be used in eco-friendly electric vehicles, hybrid vehicles, etc. to ameliorate the effects of climate change by suppressing air pollution and greenhouse gas emissions.

In some embodiments of the present disclosure, a battery module includes: a plurality of battery cells; and a battery case accommodating the plurality of battery cells and including a first cover covering the plurality of battery cells and a second cover facing the plurality of battery cells in a stacking direction of the plurality of battery cells, wherein the second cover includes: a body portion facing the plurality of battery cells; a first flange portion disposed inside the battery case and protruding from the body portion toward the first cover; and a second flange portion disposed outside the battery case, facing the first flange portion, and protruding from the body portion toward the first cover.

The first flange portion and the second flange portion may be spaced apart from each other in a first direction in which the plurality of battery cells are stacked, and the first cover may be at least partially disposed between the first flange portion and the second flange portion.

The first cover may include: a plate portion facing the plurality of battery cells in a direction, perpendicular to the first direction; and an extension portion bent from the plate portion toward the second cover, wherein at least a portion of the extension portion may be disposed between the first flange portion and the second flange portion.

The first flange portion may protrude further toward the first cover than the second flange portion, such that a protruding surface of the first flange portion may be disposed to be closer to the first cover than a protruding surface of the second flange portion.

An extension length of the extension portion may be 1.5 times or more a thickness of the plate portion and 1 or less times a protrusion length of the first flange portion.

The first cover may include at least one of an upper cover disposed above the plurality of battery cells or a lower cover disposed below the plurality of battery cells.

The battery module may further include: a welded portion fixing the first cover and the second cover to each other, wherein the welded portion may include at least one of a first welded portion formed in a position in which the extension portion and the second flange portion face each other or a second welded portion formed between the extension portion and a protruding surface of the second flange portion.

A chamfer portion may be formed on the protruding surface of the second flange portion, and the second welded portion may be formed between the extension portion and the chamfer portion.

The second cover may include a welded through-portion formed through the second flange portion in a position facing the extension portion, and the first welded portion may be formed in the welded through-portion.

The welded through-portion may include at least one of a welding hole provided as a hole or a welding slit extending in a length direction of the second cover.

The battery module may further include: a welding mark disposed on a surface of the battery case in which the welded portion may be formed to identify the welded portion.

The welding mark may be formed on the extension portion so as to be exposed to the outside of the battery case.

In some embodiments of the present disclosure, a battery module includes: a first cover; and a second cover disposed to be adjacent to the first cover and into which at least a portion of the first cover may be inserted, wherein the second cover includes: a body portion; a first flange portion protruding from one side of the body portion toward the first cover; and a second flange portion facing the first flange portion and protruding from the other side of the body portion toward the first cover.

The first cover may include: a plate portion disposed to be perpendicular to the body portion; and an extension portion bent from the plate portion toward the second cover, wherein at least a portion of the extension portion may be disposed between the first flange portion and the second flange portion.

The battery module may further include: a welded portion fixing the first cover and the second cover to each other, wherein the welded portion may include at least one of a first welded portion formed in a position in which the extension portion and the second flange portion face each other or a second welded portion formed between the extension portion and a protruding surface of the second flange portion.

### BRIEF DESCRIPTION OF DRAWINGS

Certain aspects, features, and advantages of the present disclosure are illustrated by the following detailed description with reference to the accompanying drawings.

FIG. 1 is a perspective view of a battery module according to a first embodiment of the present disclosure;

FIG. 2 is an exploded view of the battery module according to the first embodiment;

FIG. 3 is a cross-sectional view taken along line I-I′ of FIG. 1;

FIG. 4 is a perspective view of a side cover of the present disclosure;

FIG. 5 is a cross-sectional view taken along line II-II′ of FIG. 4;

FIG. 6 is an enlarged view of portion A of FIG. 3;

FIG. 7 is an enlarged view of portion B of FIG. 3;

FIG. 8 is a diagram illustrating joining through first welding;

FIG. 9 is a diagram illustrating joining through second welding;

FIG. 10 is a diagram illustrating another embodiment of FIG. 9;

FIG. 11 is a perspective view of a battery module according to a second embodiment of the present disclosure;

FIG. 12 is a perspective view of a battery module according to a third embodiment of the present disclosure;

FIG. 13 is a perspective view of a side cover according to the third embodiment;

FIG. 14 is a perspective view of a battery module according to a fourth embodiment of the present disclosure; and

FIG. 15 is a perspective view of a side cover according to the fourth embodiment.

### DETAILED DESCRIPTION

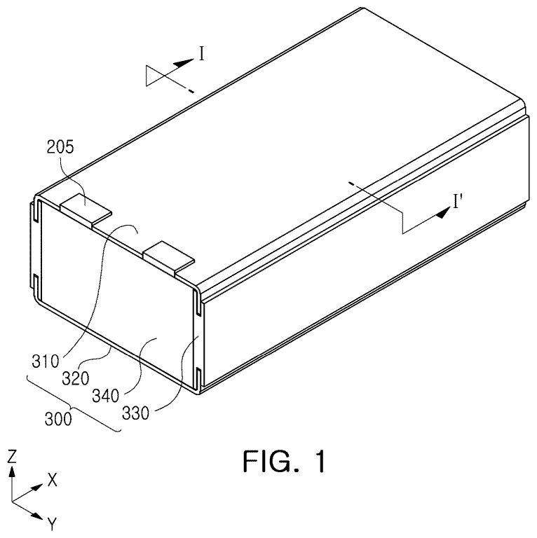

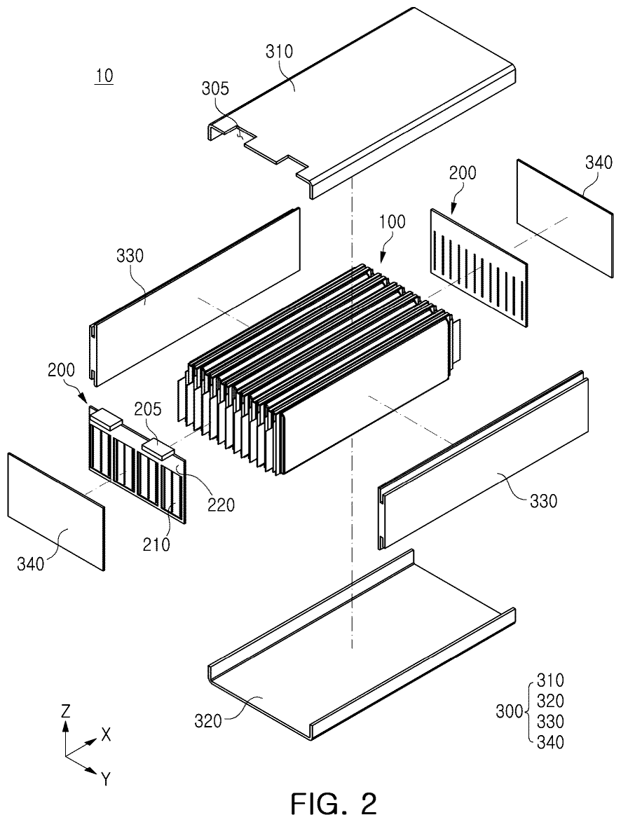

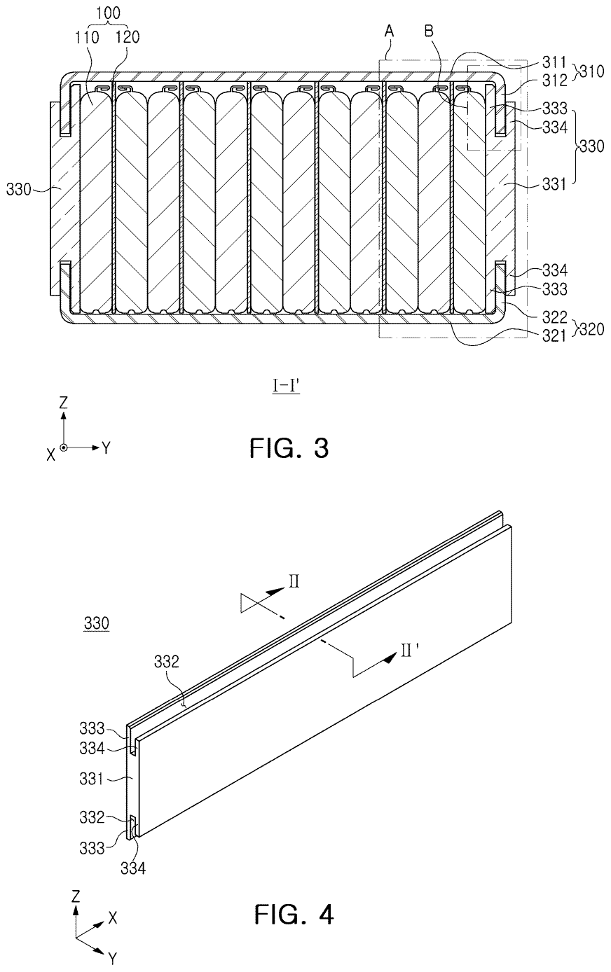

FIG. 1 is a perspective view of a battery module according to a first embodiment of the present disclosure, FIG. 2 is an exploded view of the battery module according to the first embodiment, and FIG. 3 is a cross-sectional view taken along line I-I′ of FIG. 1.

Referring to FIGS. 1 to 3 together, a battery module 10 according to the first embodiment may include a cell assembly 100 including a plurality of battery cells 110 and a battery case 300 accommodating the cell assembly 100 therein.

Specifically, the battery module 10 according to an embodiment of the present disclosure may include the battery case 300 including a plurality of battery cells 110, first covers 310 and 320 accommodating the plurality of battery cells 110 and covering the plurality of battery cells 110, and a second cover 330 facing the plurality of battery cells 110 in a stacking direction of the plurality of battery cells 110. Here, the second cover 330 may include a body portion 331 facing the plurality of battery cells 110; a first flange portion 333 disposed inside the battery case 300 and protruding from the body portion 331 toward the first covers 310 and 320; and a second flange portion 334 disposed outside the battery case 300, facing the first flange portion 333, and protruding from the body portion 331 toward the first covers 310 and 320.

The cell assembly 100 may include a plurality of battery cells 110. The battery cell 110 of the present disclosure may include a case accommodating an electrode assembly therein and a lead tab disposed on at least one side of the case. The lead tab may electrically connect an external power source to the electrode assembly.

The electrode assembly may be configured by stacking positive and negative electrode plates with wide surfaces thereof facing each other and a separator interposed therebetween. The separator may be configured to prevent an electrical short circuit between the positive and negative electrode plates and to cause a flow of ions. For example, the separator may include a porous polymer film or a porous non-woven fabric. In addition, the electrode assembly may be accommodated in a case in various manners, such as a stacking type, a zigzag folding type, a stack-folding type, and the like, in a jelly roll type formed by winding in a predetermined direction. In addition, the battery cell 110 of the present disclosure may be a lithium-ion secondary battery, but is not limited thereto. For example, the battery cell may be a nickel-cadmium battery, nickel-metal hydride battery, or nickel-hydrogen battery that may be charged with and discharged of electricity. Meanwhile, the battery cell 110 of the present disclosure may be provided as a type, such as a pouch-type, a prismatic-type, or a cylindrical-type battery cell depending on the structure of the case. In the drawing, the battery cell 110 is illustrated as a pouch cell having a case in the shape of a pouch, but the present disclosure is not limited thereto, and it is obvious that types, such as a prismatic or cylindrical-type battery cell may also be used.

Meanwhile, the cell assembly 100 of the present disclosure may further include a cell pad 120 disposed between the plurality of battery cells 110. The cell pad 120 may include at least one of an elastic pad having elasticity capable of absorbing swelling pressure of the battery cell 110 or a heat blocking pad capable of minimizing heat transfer between adjacent battery cells 110. However, this is merely an example, and the present disclosure is not limited thereto.

The battery module 10 of the present disclosure may further include a busbar assembly 200 electrically connected to the plurality of battery cells 110. The busbar assembly 200 may be disposed to face the cell assembly 100 and may include a plurality of busbars 210 electrically connected to the plurality of battery cells 110, a support frame 220 supporting the busbars 210, and a terminal 205 connected to at least one of the plurality of busbars 210 and exposed to the outside of the battery case 300. According to an embodiment, the terminal 205 may be exposed externally through a terminal hole 305 of the battery case 300. In the drawing, the terminal hole 305 is illustrated as being formed in the upper cover 310, but the present disclosure is not limited thereto.

The battery case 300 may include the first covers 310 and 320 supporting or covering the cell assembly 100, the second covers 330 facing each other in the stacking direction of the plurality of battery cells 110, and third covers 340 disposed on portions not covered by the first cover and the second cover.

Specifically, the battery case 300 of the present disclosure may include the first covers 310 and 320 and the second covers 330 disposed adjacent to the first covers 310 and 320 and into which at least portions of the first covers 310 and 320 are inserted, and the second cover 330 may include a body portion 331, a first flange portion 333 protruding from one side of the body portion 331 toward the first covers 310 and 320, and a second flange portion 334 facing the first flange portion 333 and protruding from the other side of the body portion 331 toward the first covers 310 and 320. The first covers 310 and 320 may include at least one of an upper cover 310 disposed above (a +Z-axis) the plurality of battery cells 110 or a lower cover disposed below (a −Z-axis) the plurality of battery cells 110.

The first cover 310 may include the upper cover 310 disposed above (the +Z-axis) the cell assembly 100 to cover the cell assembly 100 and the lower cover 320 disposed below (the −Z-axis) the cell assembly 100 to support the cell assembly 100.

The upper cover 310 may include a first plate portion 311 covering the cell assembly 100 and a first extension portion 312 bent from the first plate portion 311 toward the second cover 330. The lower cover 320 may include a second plate portion 321 supporting the cell assembly 100 and a second extension portion 322 bent from the second plate portion 321 toward the second cover 330. According to an embodiment, the extension portions 312 and 322 may be bent and extend in a height direction (the Z-axis). In other words, the first covers 310 and 320 may include the plate portions 311 and 321 facing the plurality of battery cells 110 in the height direction (the Z-axis) and the extension portions 312 and 322 bent from the plate portions 311 and 321 toward the second cover 330. Here, at least a portion of the extension portions 312 and 322 may be disposed between the first flange portion 333 and the second flange portion 334.

Meanwhile, in the present disclosure, the first covers 310 and 320 may be interpreted as including at least one of the upper cover 310 or the lower cover 320.

The second cover 330 may be disposed to face the cell assembly 100 in the stacking direction (a Y-axis) of the plurality of battery cells 110. The second cover 330 may include the body portion 331 facing the plurality of battery cells 110 and the first flange portion 333 and the second flange portion 334 protruding from the body portion 331 toward the first covers 310 and 320.

The third cover 340 may be disposed to face the busbar assembly 200 and to form at least one surface of the battery case 300. However, this is only an example, and the second cover 330 may be disposed in the location at which the third cover 340 is disposed.

Hereinafter, the second cover 330 will be described in more detail with reference to the drawings.

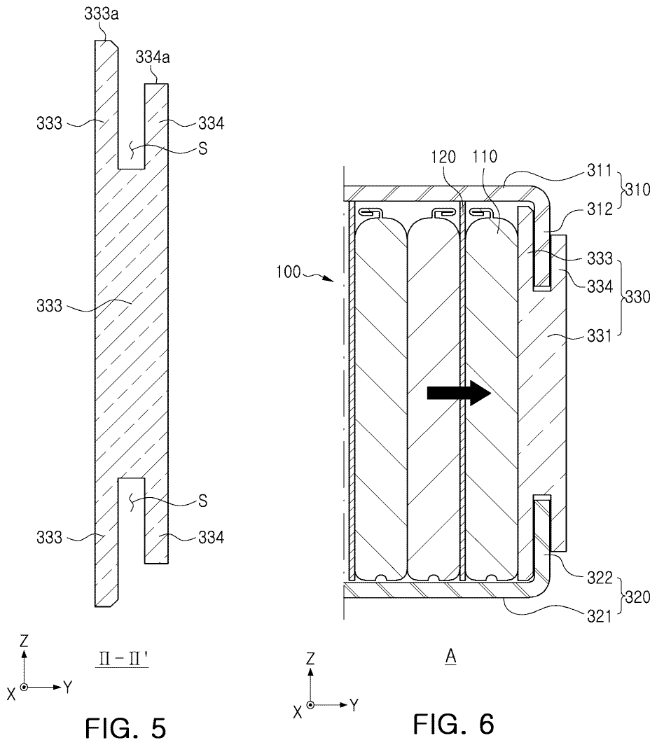

FIG. 4 is a perspective view of the side cover of the present disclosure, and FIG. 5 is a cross-sectional view taken along line II-II′ of FIG. 4. Referring to FIGS. 4 and 5 together, the first flange portion 333 may protrude in a direction (the Z-axis), perpendicular to the stacking direction (the Y-axis) of the plurality of battery cells 110 in the internal space of the battery case 300, and the second flange portion 334 may protrude in the direction (the Z-axis) outside the battery case 300. According to an embodiment, the first flange portion 333 and the second flange portion 334 may be spaced apart in the direction (the Y-axis) in which the plurality of battery cells 110 are stacked, and at least a portion of the first covers 310 and 320 may be disposed between the first flange portion 333 and the second flange portion 334.

Specifically, the extension portions 312 and 322 of the first covers 310 and 320 may be inserted into an insertion space S formed between the first flange portion 333 and the second flange portion 334. Here, the ‘insertion space S’ may be defined as a space formed by one surface of the body portion 331, one surface of the first flange portion 333, and one surface of the second flange portion 334. Meanwhile, in the drawing, the first and second flange portions 333 and 334 are illustrated as protruding to both sides toward the upper cover 310 and the lower cover 320, but the present disclosure is not limited thereto, and any flange portion protruding toward at least one side may be included in the present disclosure.

FIG. 6 is an enlarged view of portion A of FIG. 3.

Referring to FIG. 6, a portion of the first covers 310 and 320 may be bent toward the second cover 330 to form the extension portions 312 and 322, and the extension portions 312 and 322 may be inserted into the second cover 330. As described below, through this structure, the battery case 300 of the present disclosure may stably support pressure applied when the battery cell 110 is swollen.

Specifically, when the battery cell 110 is swollen, pressure is applied in the direction of the arrow (the Y-axis) of the drawing. The extension portions 312 and 322 of the first covers 310 and 320 primarily support the pressure. Here, since the extension portions 312 and 322 are sandwiched between the first flange 333 and the second flange portion 334 to be supported, the expansion of the extension portions 312 and 322 due to the swelling pressure may be delayed. In addition, the swelling pressure may be supported more stably by welded portions W1 and W2 described below.

Hereinafter, a joining structure between the first covers 310 and 320 and the second cover 330 will be described in more detail with reference to the drawings.

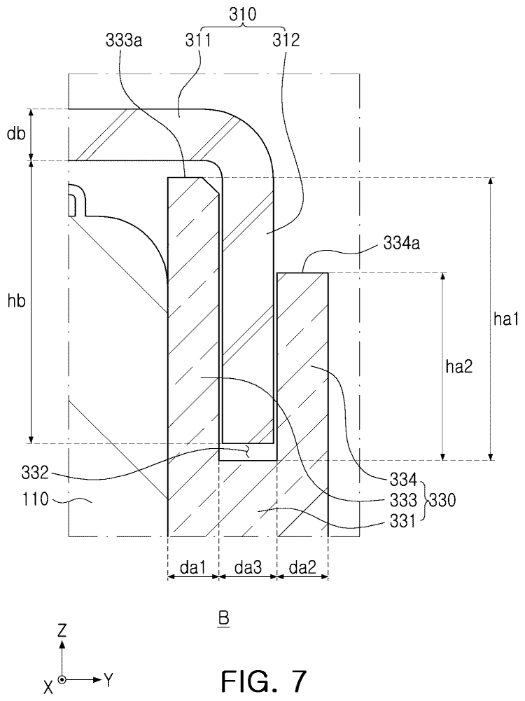

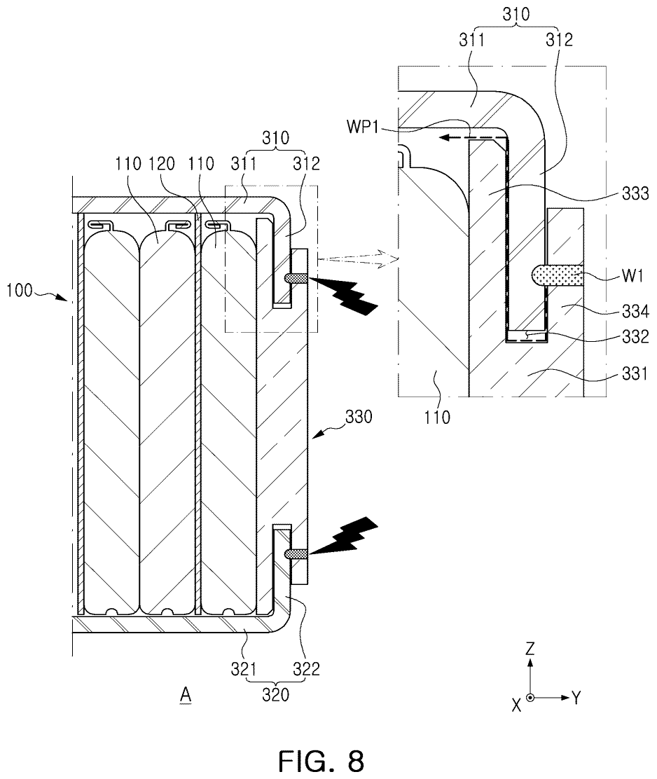

FIG. 7 is an enlarged view of portion B of FIG. 3. In FIG. 7, only the upper cover 310 among the first covers 310 and 320 is described as an example, but this is only for the convenience of understanding, the present disclosure is not limited thereto, and it should be understood that the same is applied to the lower cover 320.

Referring to FIG. 7, the first covers 310 and 320 may have a thickness db smaller than a distance da3 between the first flange portion 333 and the second flange portion 334 so that the first covers 310 and 320 may be inserted into the insertion space S.

In addition, an extension length hb of the extension portions 312 and 322 of the first covers 310 and 320 may be provided appropriately to support the swelling pressure. If the extension length hb is too small, it may be structurally difficult to withstand the swelling pressure, and if the extension length hb is too large, it may be difficult to insert into the second cover 330. According to an embodiment, the extension length hb may be 1.5 times or more the thickness db of the first covers 310 and 320 and 1 or less times the protrusion length ha1 of the first flange portion 333.

A thickness (da1+da2+da3) of the second cover 330 may be provided to be greater than the thickness db of the first covers 310 and 320. The thickness da1 of the first flange portion 333 and the thickness da2 of the second flange portion 334 are not particularly limited. Although they are illustrated as being the same in the drawing, the present disclosure is not limited thereto. The distance da3 between the first flange portion 333 and the second flange portion 334 is sufficient to the extent that the extension portions 312 and 322 may be inserted.

According to an embodiment, the thickness da1 of the first flange portion 333 may be equal to or greater than the thickness da2 of the second flange portion 334. Specifically, since the first flange portion 333 has to withstand the swelling pressure of the battery cell 110 together with the first covers 310 and 320, it is advantageous in terms of durability to form the thickness da1 to be large, and since the second flange portion 334 is welded, it may be advantageous in terms of joining to form the thickness da2 to be relatively small. For example, the thickness da1 of the first flange portion 333 may be 1 or more and 1.5 or less the thickness of the second flange portion 334. However, the present disclosure is not limited thereto, and the thickness da1 of the first flange portion 333 may be smaller than the thickness da2 of the second flange portion 334.

According to an embodiment, the distance da3 between the first flange portion 333 and the second flange portion 334 may be larger than the thickness db of the first covers 310 and 320 in consideration of the assembly tolerance. For example, the distance da3 between the first flange portion 333 and the second flange portion 334 may be 1 to 1.2 times the thickness db of the first covers 310 and 320. However, this is only an example, and there is no particular limitation in the size as long as the first covers 310 and 320 may be inserted into the second cover 330.

According to an embodiment, a protruding surface 333a of the first flange portion 333 may be disposed to be closer to the plate portions 311 and 312 than a protruding surface 334a of the second flange portion 334. Specifically, a protrusion length ha1 of the first flange portion 333 may be greater than a protrusion length ha2 of the second flange portion 334.

In addition, according to an embodiment, extension portion surfaces of the first covers 310 and 320 may be disposed to be close to the body portion 331. In other words, the first protruding surface 333a may be disposed to be close to the plate portions 311 and 321, the extension portion surface may be disposed to be close to the body portion 331, and the second protruding surface 334a may be disposed between the first protruding surface 333a and the extension portion surface in the height direction (the Z-axis).

Meanwhile, since the first flange portion 333 is directly subjected to swelling pressure from the inside of the battery case 300 and transmits the swelling pressure to the extension portions 312 and 322, a larger region in contact with the extension portions 312 and 322 may be advantageous in terms of the durability. Accordingly, among the first protrusion length ha1 and the second protrusion length ha2, the first protrusion length ha1 may be provided as a value closer to the extension length hb. Accordingly, the surface contact region between the first flange portion 333 and the extension portions 312 and 322 may increase. However, this is only an example, the present disclosure is not necessarily limited to the above-described size, and the first protrusion length ha1 and the second protrusion length ha2 may be the same, or the second protrusion length ha2 may be larger.

Meanwhile, as described below, in terms of a welding structure between the first covers 310 and 320 and the second cover 330 and in terms of extending a transmission path of heat generated during welding, it is preferable that the first protrusion length ha1 be larger than the second protrusion length ha2.

According to an embodiment, the first protrusion length ha1 may be 1.2 or more and 1.5 or less than the second protrusion length ha2. However, this is only an example, and the protrusion lengths ha1 and ha2 are not particularly limited as long as the first covers 310 and 320 may be inserted into the second cover 330.

Hereinafter, the welding structure between the first covers 310 and 320 and the second cover will be described with reference to the drawings.

FIG. 8 is a diagram illustrating welding performed at a first welded portion. Referring to FIG. 8, welding may be performed through the second flange portion 334.

Specifically, a portion in which the extension portions 312 and 322 and the second flange portion 334 are in contact with each other may be welded to form a first welded portion W1. Welding may be performed by applying heat to a portion in which outer surface of the extension portions 312 and 322 and an inner surface of the second flange portion 334 are in contact with each other. Here, the portion in which the extension portions 312 and 322 and the second flange portion 334 are in contact with each other may be referred to as a first welded region, and the first welded portion W1 may be formed in the first welded region. That is, according to an embodiment, the welded portion W1 may be formed through butt welding. Through such welding, the battery case 300 of the present disclosure may more firmly fix the first covers 310 and 320 and the second cover 330 and may be provided to withstand a greater swelling pressure.

Meanwhile, heat generated when forming the first welded portion W1 may move to the inside of the battery case 300 through a first heat transfer path WP1. Since the second cover 320 of the present disclosure is provided in a shape like ‘H’ due to the flange portions 333 and 334, the first heat transfer path WP1 may be extended. That is, as the distance of the first heat transfer path WP1 is extended, the influence of welding heat applied to the battery cell 110 may be reduced.

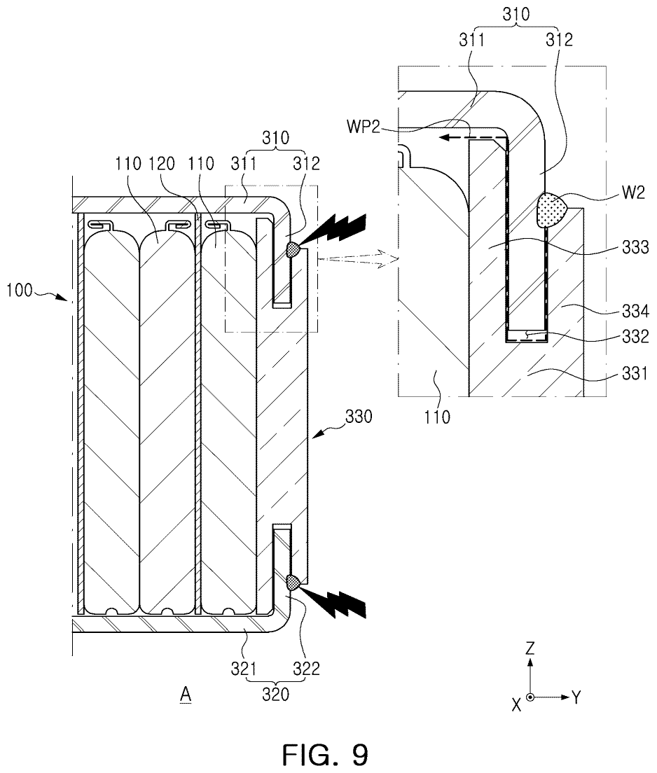

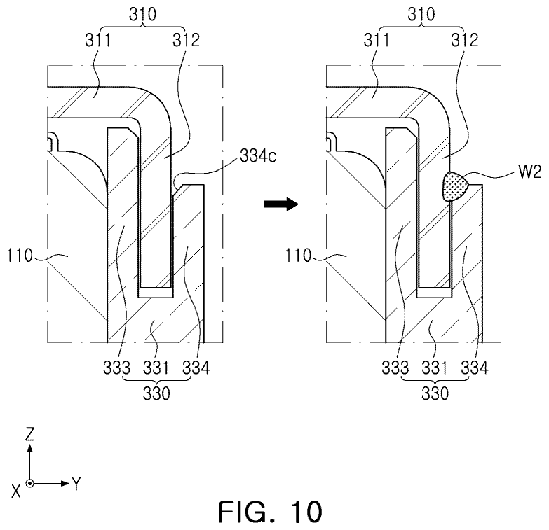

FIG. 9 is a diagram illustrating welding performed in a second welded region, and FIG. 10 is a diagram illustrating another embodiment of FIG. 9.

Referring to FIG. 9, welding may be performed at the end portion of the second flange portion 334. Specifically, the outer surface of the extension portions 312 and 322 and the protruding surface 334a of the second flange portion 334 may be welded to form a second welded portion W2. Here, a region between the outer surface of the extension portions 312 and 322 and the protruding surface 334a of the second flange portion 334 may be referred to as a second welded region, and the second welded portion W2 may be formed in the second welded region. That is, according to an embodiment, the welded portion W2 may be formed through lap welding.

In addition, heat generated when the second welded portion W2 is formed may move to the inside of the battery case 300 through a second heat transfer path WP2. The second cover 320 of the present disclosure is provided in a shape like ‘H’ due to the flange portions 333 and 334, so that the second heat transfer path WP2 may be extended. That is, as the distance of the second heat transfer path WP2 is extended, the influence of welding heat applied to the battery cell 110 may be reduced.

The welded portions W1 and W2 of the present disclosure may include at least one of the first welded portion W1 formed in a position in which the extension portions 312 and 322 and the second flange portion 334 face each other or the second welded portion W2 formed between the extension portions 312 and 322 and the protruding surface 334a of the second flange portion 334. In this manner, although two welding structures have been described with reference to FIGS. 8 and 9, the welding method of the welded portions W1 and W2 of the present disclosure is an example, and the present disclosure is not limited thereto.

Referring to FIG. 10, during lap welding at the second welded region, a chamfer portion 334c may be formed on the protruding surface 334a of the second flange portion 334 to obtain higher welding strength, and the second welded portion W2 may be formed between the extension portions 312 and 322 and the chamfer portion 334c. The second welded portion W2 is deeply seated in a base material by the chamfer portion 334c, and a joint portion is evenly formed to obtain higher strength.

In this manner, various welding methods may be applied to the battery case 300 according to the present disclosure, the durability of the case may increase. Hereinafter, battery modules 20, 30, and 40 of various embodiments according to the battery case 300 including various structures of the present disclosure will be described. Here, descriptions that are redundant with those of the battery module 10 of the first embodiment in the battery modules 20, 30, and 40 of the second to fourth embodiments are omitted.

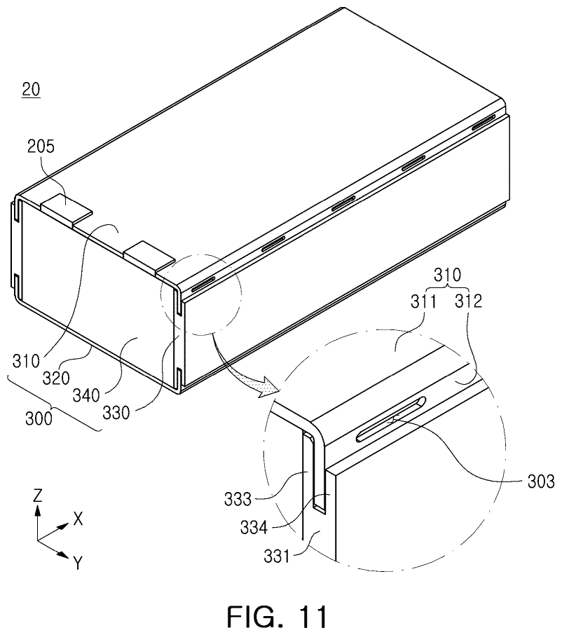

FIG. 11 is a perspective view of a battery module according to a second embodiment of the present disclosure. Referring to FIG. 11, the first covers 310 and 320 may further include a welding mark 303 for identifying a welded region.

According to an embodiment, the welding mark 303 may be further included to be disposed on a surface in which the welded portions W1 and W2 are formed among the surfaces of the battery case 300, in order to identify the welded portions W1 and W2. The welding mark 303 may not only display the surface in which the welded portions W1 and W2 are formed, but may also display that the welded portions W1 and W2 is formed nearby. The welding mark 303 may be formed by at least partially depressing the outer surface of the extension portions 312 and 322. A welding device (not illustrated) may detect the surface in which the welded portions W1 and W2 are formed and the position of the welded portions W1 and W2 by identifying the shade and depth according to the mark 303.

The welding mark 303 may be disposed on the extension portions 312 and 322 so as to be exposed externally. In addition, the welding mark 303 may be disposed to be adjacent to the welded portions W1 and W2. For example, the welding mark 303 may be disposed on the extension portions 312 and 322 on the side in which the welded portions W1 and W2 are formed, which are not covered by the second flange portion 334. That is, the welding mark 303 may be disposed between the plate portions 311 and 321 and the second flange portion 334.

Meanwhile, according to the present disclosure, welding through-portions 335 and 336 providing a separate space for welding may be included in the second cover 330. The welding through-portions 335 and 336 may include at least one of a welding hole 335 provided in a hole shape and a welding slit 336 extending in a length direction (an X-axis) of the second cover 330.

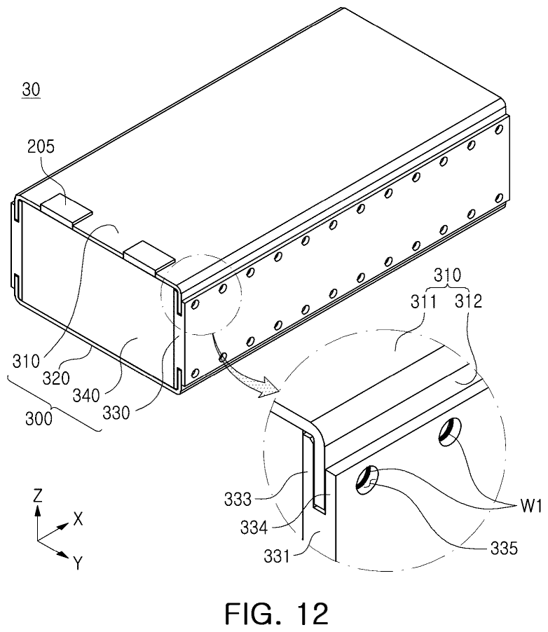

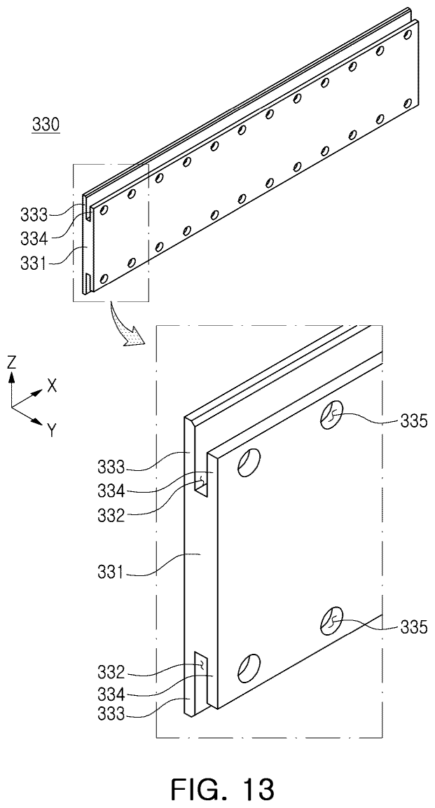

FIG. 12 is a perspective view of a battery module according to a third embodiment of the present disclosure, and FIG. 13 is a perspective view of a side cover according to the third embodiment. A battery case 300 of a battery module 30 according to the third embodiment may include a welding hole 335.

Referring to FIGS. 12 and 13 together, at least one welding hole 335 may be disposed in the length direction (the X-axis) in the second flange portion 334. As described above with reference to FIG. 8, butt welding may be performed at the first welded region to form the first welded portion W1. That is, the first welded portion W1 may be formed in the welding hole 335. According to the third embodiment, since welding is performed on the welding hole 335, the first welded portion W1 may be exposed externally by the welding hole 335. That is, the first welded portion W1 may be formed in the welding hole 335 and may be exposed to the outside of the battery case 300. Through this, an external appearance inspection of the first welded portion W1 may be facilitated. In addition, the area of the welded portion W1 may be increased to increase the structural strength.

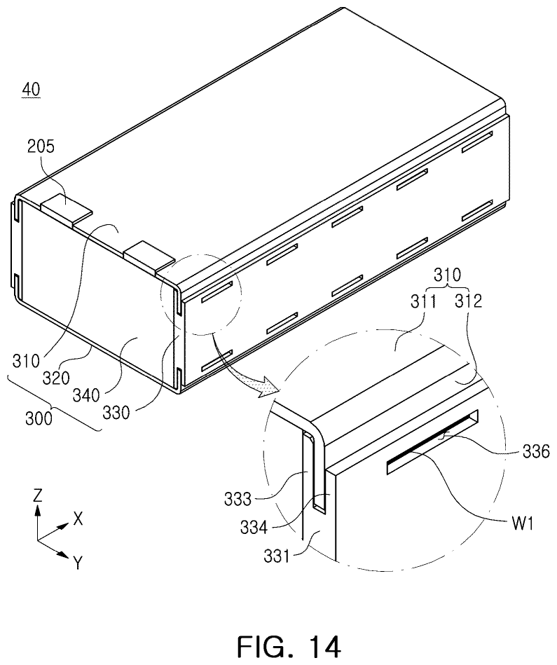

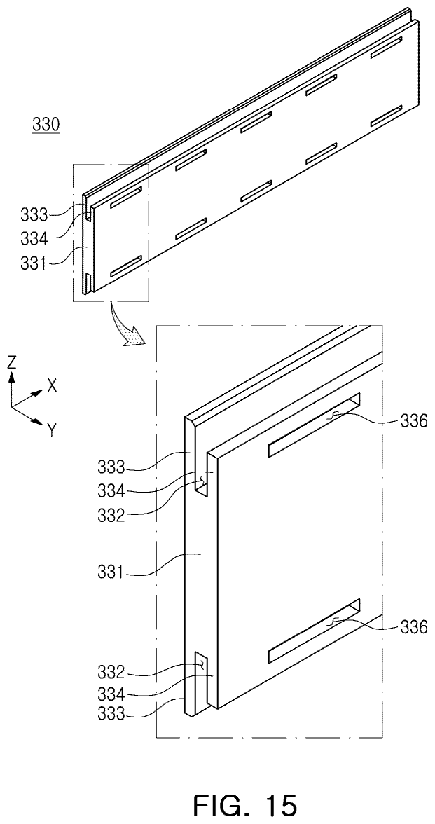

FIG. 14 is a perspective view of a battery module according to a fourth embodiment of the present disclosure, and FIG. 15 is a perspective view of a side cover according to the fourth embodiment. The battery case 300 of a battery module 40 according to the fourth embodiment may include a welding slit 336.

Referring to FIGS. 14 and 15, at least one welding slit 336 may be disposed in the length direction (the X-axis) in the second flange portion 334. As described above with reference to FIG. 8, butt welding may be performed on the first welded portion to form the first welded portion W1. That is, the first welded portion W1 may be formed in the welding slit 336. According to the fourth embodiment, since welding is performed through the welding slit 336, the first welded portion W1 may be exposed externally by the welding hole 335. That is, the welding slit 336 may perform the same function as that of the welding hole 335 described above.

The battery modules 10, 20, 30, and 40 according to the first to fourth embodiments described above may be applied together if they do not structurally run counter to each other. The present disclosure may include all of the welding mark 303, the welding hole 335, and the welding slit 336.

The battery case and the battery module including the same according to an embodiment of the present disclosure may stably support pressure due to swelling of the battery cell.

The battery case and the battery module including the same according to an embodiment of the present disclosure may perform welding efficiently.

The battery case and the battery module including the same according to an embodiment of the present disclosure may provide a structure capable of delaying or reducing the transmission of heat generated during welding to the battery cell.

Only specific examples of implementations of certain embodiments are described. Variations, improvements and enhancements of the disclosed embodiments and other embodiments may be made based on the disclosure of this patent document.

What is claimed is:

1. A battery module comprising:
a plurality of battery cells; and
a battery case accommodating the plurality of battery cells and including a first cover covering the plurality of battery cells and a second cover facing the plurality of battery cells in a stacking direction of the plurality of battery cells,
wherein the second cover includes:
a body portion facing the plurality of battery cells;
a first flange portion disposed inside the battery case and protruding from the body portion toward the first cover; and
a second flange portion disposed outside the battery case, facing the first flange portion, and protruding from the body portion toward the first cover.

2. The battery module of claim 1, wherein
the first flange portion and the second flange portion are spaced apart from each other in a first direction in which the plurality of battery cells are stacked, and
the first cover is at least partially disposed between the first flange portion and the second flange portion.

3. The battery module of claim 2, wherein
the first cover includes:
a plate portion facing the plurality of battery cells in a direction, perpendicular to the first direction; and
an extension portion bent from the plate portion toward the second cover,
wherein at least a portion of the extension portion is disposed between the first flange portion and the second flange portion.

4. The battery module of claim 3, wherein the first flange portion protrudes further toward the first cover than the second flange portion, such that a protruding surface of the first flange portion is disposed to be closer to the first cover than a protruding surface of the second flange portion.

5. The battery module of claim 3, wherein an extension length of the extension portion is 1.5 times or more a thickness of the plate portion and 1 or less times a protrusion length of the first flange portion.

6. The battery module of claim 1, wherein the first cover includes at least one of an upper cover disposed above the plurality of battery cells or a lower cover disposed below the plurality of battery cells.

7. The battery module of claim 3, further comprising
a welded portion fixing the first cover and the second cover to each other,
wherein the welded portion includes at least one of a first welded portion formed in a position in which the extension portion and the second flange portion face each other or a second welded portion formed between the extension portion and a protruding surface of the second flange portion.

8. The battery module of claim 7, wherein a chamfer portion is formed on the protruding surface of the second flange portion, and the second welded portion is formed between the extension portion and the chamfer portion.

9. The battery module of claim 7, wherein
the second cover includes a welded through-portion formed through the second flange portion in a position facing the extension portion, and
the first welded portion is formed in the welded through-portion.

10. The battery module of claim 9, wherein the welded through-portion includes at least one of a welding hole provided as a hole or a welding slit extending in a length direction of the second cover.

11. The battery module of claim 7, further comprising a welding mark disposed on a surface of the battery case in which the welded portion is formed to identify the welded portion.

12. The battery module of claim 11, wherein the welding mark is formed on the extension portion so as to be exposed to the outside of the battery case.

13. A battery module comprising:
a first cover; and
a second cover disposed to be adjacent to the first cover and into which at least a portion of the first cover is inserted,
wherein the second cover includes:
a body portion;
a first flange portion protruding from one side of the body portion toward the first cover; and
a second flange portion facing the first flange portion and protruding from the other side of the body portion toward the first cover.

14. The battery module of claim 13, wherein the first cover comprises:
a plate portion disposed to be perpendicular to the body portion; and
an extension portion bent from the plate portion toward the second cover,
wherein at least a portion of the extension portion is disposed between the first flange portion and the second flange portion.

15. The battery module of claim 14, further comprising:
a welded portion fixing the first cover and the second cover to each other,
wherein the welded portion includes at least one of a first welded portion formed in a position in which the extension portion and the second flange portion face each other or a second welded portion formed between the extension portion and a protruding surface of the second flange portion.
